(19) United States
(12) Patent Application Publication
(10) Pub. No.: US 2011/0028613 A1
(43) Pub. Date: Feb. 3, 2011

(54) FLAME-RETARDENT THERMOPLASTIC COMPOSITIONS

(75) Inventors: Maarten Staal, Mannheim, NC (US); Piyada Charoensirisomboon, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/935,617

(22) PCT Filed: Mar. 30, 2009
(86) PCT No.: PCT/EP09/53702

§ 371 Date: Sep. 30, 2010

(51) Int. Cl. C08K 5/51; C07F 9/40

(52) U.S. Cl. 524/121; 558/155

(57) ABSTRACT

The invention relates to thermoplastic molding compositions comprising
A) from 39 to 99% by weight of at least one thermoplastic polymer,
B) from 1 to 60% by weight of a flame-retardant component comprising
   B1) a compound of the formula (I),

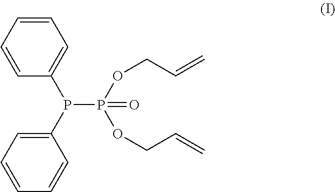

and
C) from 0 to 60% by weight of further additives,
   where the percentages by weight are always based on the total weight of components A) to C) and their total is 100% by weight,
   and also to processes for the preparation of these molding compositions, to the use of these molding compositions for the production of moldings, of fibers, of foams, or of foils, and also to the resultant moldings, fibers, foams, or foils and moreover to the use of the compound of the formula (I) as flame retardant for thermoplastic polymers.

The invention relates to thermoplastic molding compositions comprising

A) from 39 to 99% by weight of at least one thermoplastic polymer,
B) from 1 to 60% by weight of a flame-retardant component comprising
B1) a compound of the formula (I),

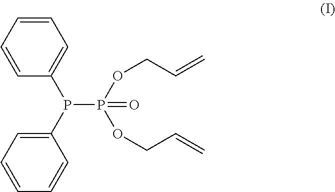

and
   C) from 0 to 60% by weight of further additives,
   where the percentages by weight are always based on the total weight of components A) to C) and their total is 100% by weight.

The present invention also relates to processes for the preparation of these molding compositions, to the use of these molding compositions for the production of moldings, of fibers, of foams, or of foils, and also to the resultant moldings, fibers, foams, or foils and moreover to the use of the compound of the formula (I) as flame retardant for thermoplastic polymers.

There is a wide variety of known flame-retardant additives for thermoplastic polymers. Halogen-free or low-halogen-content flame retardants are advantageous since the amount of toxic fire gases released in the event of a fire is smaller when these are used. Halogen-free flame retardants described in the literature are, for example, a wide variety of different phosphorus compounds.

WO 00/34367 and WO 00/34342 disclose halogen-free flame-retardant thermoplastics which comprise expandable graphite and a phosphorus compound as flame-retardant components. However, molding compositions having this type of flame-retardant modification are not entirely satisfactory in terms of their combustion behavior, in particular in terms of drop behavior in the event of a fire.

WO 2005/103136 discloses flame-retardant thermoplastics, which comprise not only expandable graphite and a phosphorus compound but also a further co-additive, which is intended to suppress migration of the phosphorus-containing flame retardant to the surface of the polymer. Polycarbonate is explicitly mentioned as co-additive.

KR1996-0001006 discloses flame-retardant thermoplastics where the flame-retardant components comprise expandable graphite, a phosphorus compound and Teflon. The average particle size of the expandable graphite is 5 μm. The Teflon is used in amounts of from 1 to 5 percent by weight as anti-drop agent. The resultant molding compositions with halogen-free flame retardancy have good heat resistance and impact resistance.

It was an object of the present invention to find a halogen-free or low-halogen flame-retardant combination which can be used for thermoplastics and which has improved flame-retardant and/or mechanical properties when compared with known systems.

The molding compositions defined in the introduction have accordingly been found, and comprise a flame-retardant component comprising a compound of the formula (I)

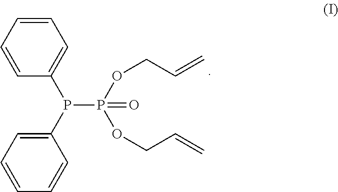

The thermoplastic molding compositions of the invention have improved flame-retardant and/or mechanical properties when compared with known halogen-free or low-halogen flame-retardant thermoplastics.

The molding compositions of the invention are described below, as also are the processes and uses which are also part of the invention.

The molding compositions of the invention comprise
A) from 39 to 99% by weight, preferably from 50 to 95% by weight, particularly preferably from 65 to 90% by weight, of component A,
B) from 1 to 60% by weight, preferably from 5 to 40% by weight, particularly preferably from 10 to 35% by weight, of component B, and
C) from 0 to 60% by weight, preferably from 0 to 45% by weight, particularly preferably from 0 to 25% by weight, of component C,
   where the percentages by weight are always based on the total weight of components A) to C) and their total is 100% by weight.

In one preferred embodiment of the invention, the flame-retardant component B) is composed exclusively of the compound of the formula (I), corresponding to component B1).

In another preferred embodiment of the invention, the flame-retardant component B) is composed of a mixture of components B1) and B2) or a mixture of components B1) and B3).

In a further preferred embodiment of the invention, the flame-retardant component B) comprises a mixture of components B1), B2) and B3. In this case, the flame-retardant component B) in particular comprises
B1) from 20 to 79.99% by weight, preferably from 30 to 69.9% by weight, particularly preferably from 40 to 59.5% by weight, of component B1),
B2) from 20 to 79.99% by weight, preferably from 30 to 69.9% by weight, particularly preferably from 40 to 59.5% by weight, of component B2) and
B3) from 0.01 to 4% by weight, preferably from 0.1 to 3% by weight, particularly preferably from 0.5 to 2% by weight, of component B3),
   where the percentages by weight are always based on the total weight of components B1) to B3) and their total is 100% by weight.

### Component A):

Any of the thermoplastic polymers known to the person skilled in the art (except fluorine-containing polymers of component B3)) and described in the literature are in principle suitable as component A) of the thermoplastic molding compositions.

The following are particularly suitable as component A): polyethylene (PE), polypropylene (PP), polyvinyl chloride (PVC), polystyrene (PS), impact-modified polystyrene (HIPS), styrene-acrylonitrile copolymers (SAN). acrylonitrile-styrene-acrylate copolymers (ASA), acrylonitrile-butadiene-styrene copolymers (ABS), methacrylate-acrylonitrile-butadiene-styrene copolymers (MABS), styrene-butadiene block copolymers (SBC), polyamide (PA), polyethylene terephthalate (PET), polyethylene terephthalate glycol (PETG), polybutylene terephthalate (PBT), polyoxymethylene (POM), polycarbonate (PC), polymethyl methacrylate (PMMA), poly(ether)sulfones (PES), thermoplastically processable polyurethane (TPU), polyphenylene oxide (PPO), foamable and/or foamed polystyrene (EPS), foamable and/or foamed polypropylene or a mixture composed of two or more of these polymers.

A particularly preferred component A) is polyethylene (PE), polypropylene (PP) or a mixture composed of these polymers.

A particularly preferred component A) is polyvinyl chloride (PVC).

A particularly preferred component A) is polystyrene (PS), impact-modified polystyrene (HIPS) or a mixture composed of these polymers.

A particularly preferred component A) is styrene-acrylonitrile copolymer (SAN).

A particularly preferred component A) is acrylonitrile-butadiene-styrene copolymer (ABS).

A particularly preferred component A) is methacrylate-acrylonitrile-butadiene-styrene copolymer (MABS).

A particularly preferred component A) is styrene-butadiene block copolymer (SBC).

A particularly preferred component A) is polyamide (PA).

A particularly preferred component A) is a mixture composed of acrylonitrile-butadiene-styrene copolymers (ABS) and polyamide (PA).

A particularly preferred component A) is polyethylene terephthalate (PET), polyethylene terephthalate glycol (PETG), polybutylene terephthalate (PBT) or a mixture composed of these polymers.

A particularly preferred component A) is polyoxymethylene (POM).

A particularly preferred component A) is polycarbonate (PC).

A particularly preferred component A) is a mixture composed of acrylonitrile-styrene-acrylate copolymers (ASA) and polycarbonate (PC).

A particularly preferred component A) is a mixture composed of acrylonitrile-butadiene-styrene copolymers (ABS) and polycarbonate (PC).

A particularly preferred component A) is a mixture composed of styrene-acrylonitrile copolymers (SAN) and polycarbonate (PC).

A particularly preferred component A) is polymethyl methacrylate (PMMA).

A particularly preferred component A) is poly(ether)sulfone (PES).

A particularly preferred component A) is thermoplastically processable polyurethane (TPU).

A particularly preferred component A) is polyphenylene oxide (PPO).

A particularly preferred component A) is foamable and/or foamed polystyrene (EPS).

A particularly preferred component A) is foamable and/or foamed polypropylene.

The polymers mentioned and their preparation are known to the person skilled in the art and described in the literature (for example in A. Echte, Handbuch der technischen Polymerchemie [Handbook of industrial polymer chemistry], VCH Verlagsgesellschaft, Weinheim, 1993; and Saechtling, Kunststoff Taschenbuch [Plastics handbook], Carl Hanser Verlag, Munich, 29th edition, 2004) and the polymers mentioned are commercially available.

### Component B):

According to the invention, the thermoplastic molding compositions comprise, as flame-retardant component B), the abovementioned components and mixtures comprising B1), B1 and B2), B1) and B3, or B1) and B2) and B3) in the quantitative proportions likewise described above.

B1) here is a compound of the formula (I),
B2) here is an expandable graphite, and
B3) here is a fluorine-containing polymer.

The molding compositions of the invention comprise, as component B1), a compound of the formula (I):

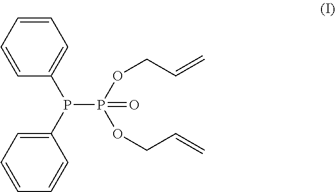

The compound of the formula (I) can be prepared as follows:

Triallyl phosphite (101 g, corresponding to 0.5 mol, commercially available from ABCR GmbH & Co. KG, Karlsruhe) is used as initial charge in toluene (500 ml) in a stirred flask. Within a period of one hour, P-chlorodiphenylphosphine (110.5 g, corresponding to 0.5 mol, commercially available from Sigma-Aldrich Laborchemikalien GmbH, Seelze) is added dropwise at 25° C. Stirring is continued at reflux for 7 hours and the mixture is then cooled. Toluene is removed by distillation at 60° C. and 1 mbar by way of a Claisen bridge. The product is dried under the vacuum provided by an oil pump. The product (147 g, 85% yield), the compound of the formula (I), is obtained as a clear yellow liquid with >80% purity (by ³¹P NMR (toluene-d₈): −31.1 (d, 1J 204 Hz); 34.1 (d, 1J 204 Hz)).

The compound of the formula (I) has particularly good suitability for use as flame retardant in thermoplastic polymers of component A). In particular, the compound of the formula (I) is to be used as flame retardant in the particularly preferred components A) described above.

The molding compositions of the invention comprise, as component B2), expandable graphite which is known to the person skilled in the art and described in the literature (heat-expandable graphite). This is generally derived from natural or synthetic graphite.

By way of example, the expandable graphite is obtainable via oxidation of natural and/or synthetic graphite. Oxidants that can be used are H₂O₂ or nitric acid in sulfuric acid.

The expandable graphite can moreover be prepared via reduction, e.g. using sodium naphthalenide in an aprotic organic solvent.

The layer-lattice structure of graphite makes it capable of forming specific types of intercalation compounds. In these intercalation compounds, foreign atoms or foreign molecules have been absorbed, sometimes in stoichiometric ratios, into the spaces between the carbon atoms.

To improve compatibility with the thermoplastic matrix, the surface of the expandable graphite can have been coated, for example with silane sizes known to the person skilled in the art.

If the expandable graphite has been obtained via the abovementioned oxidation process, it can be necessary to add an alkaline compound, since the expandable graphite can otherwise (by virtue of the acid comprised) cause corrosion of the molding compositions and/or of the storage apparatuses and production apparatuses for these molding compositions. In particular, amounts of up to 10% by weight, preferably up to 5% by weight (based on 100% by weight of B1) of alkali metal compounds, or of Mg(OH)₂, or Al hydroxides, can be added. The mixing process advantageously takes place before the components are compounded.

The coefficient of thermal expansion (“specific volume change”) of the expandable graphite on rapid heating from room temperature to 800° C. (in the direction of the c-axis of the crystal) is preferably at least 100 ml/g, preferably at least 110 ml/g.

For suitability as flame retardant it is important that the expandable graphite does not expand to any major extent at temperatures below 270° C., preferably below 280° C. This is understood by the person skilled in the art to mean that the volume expansion of the expandable graphite is less than 20% within a period of 10 min at the temperatures mentioned.

The coefficient of expansion (as specific parameter) generally means the difference between the specific volume (ml/g) after heating and the specific volume at room temperature of 20° C. This is generally measured by the following method: a quartz container is heated in an electric furnace to 1000° C. 2 g of the expandable graphite are rapidly placed in the quartz container and this is kept in the furnace for 10 sec.

The weight of 100 ml of the expanded graphite is measured in order to determine the “loosened apparent specific gravity”. The reciprocal is then the specific volume at said temperature. The specific volume at room temperature is correspondingly measured at 20° C. (Coefficient of expansion=spec. volume after heating−specific volume at 20° C.).

The average particle size D₅₀ of the expandable graphite B2) is generally from 10 μm to 1000 μm, preferably from 30 μm to 850 μm, particularly preferably from 200 μm to 700 μm (the average particle size D₅₀ and the particle size distribution being determined from the cumulative volume distribution). The average particle sizes D₅₀ are in all cases the volume-average particle sizes determined on the dry powder by means of laser light scattering in a Malvern Mastersizer 2000. Laser light scattering provides the cumulative particle diameter distribution of a specimen. From this it is possible to determine the percentage of the particles whose diameter is smaller than or equal to a certain size. The average particle diameter D₅₀, also termed the D₅₀ value of the cumulative volume distribution, is that particle diameter for which the diameter of 50% by weight of the particles is smaller than the diameter corresponding to the D₅₀ value. Similarly, the diameter of 50% by weight of the particles is then greater than the D₅₀ value.) If the average particle sizes D₅₀ are lower, the flame retardancy achieved is generally insufficient; if they are greater, the mechanical properties of the thermoplastic molding compositions are usually adversely affected.

The density of the expandable graphite is usually in the range from 0.4 to 2 g/cm³.

The molding compositions comprise, as component B3), a fluorine-containing polymer different from component A). Fluorine-containing ethylene polymers are preferred. These are polymers of ethylene whose fluorine content is from 55 to 76% by weight, preferably from 70 to 76% by weight.

Examples here are polytetrafluoroethylene (PTFE), tetrafluoroethylene-hexafluoropropylene copolymers or tetrafluoroethylene copolymers having relatively small proportions (generally up to 50% by weight) of copolymerizable ethylenically unsaturated monomers. These are described by way of example by Schildknecht in “Vinyl and Related Polymers”, Wiley-Verlag, 1952, pages 484 to 494, and by Wall in “Fluorpolymers” [Fluoropolymers] (Wiley Interscience, 1972).

These fluorine-containing ethylene polymers have homogeneous distribution in the molding compositions and their average particle size D₅₀ is preferably in the range from 0.05 to 10 μm, in particular from 0.1 to 5 μm. These small particle sizes can particularly preferably be achieved via use of aqueous dispersions of fluorine-containing ethylene polymers and their incorporation into a polymer melt.

The flame-retardant component B) can in principle comprise further flame-retardant compounds, alongside the components mentioned B1), B2) and B3). Examples of suitable compounds are organic and inorganic phosphorus-containing compounds, in which the valence state of the phosphorus is from −3 to +5. The valence state is to be understood as the “oxidation state” as set out in Lehrbuch der Anorganischen Chemie [Textbook of inorganic chemistry] from A. F. Hollemann and E. Wiberg, Walter des Gruyter and Co. (1964, 57th to 70th edition), pages 166 to 177. Phosphorus compounds of the valence states from −3 to +5 derive from phosphine (−3), diphosphine (−2), phosphine oxide (−1), elemental phosphorus (+0), hypophosphorous acid (+1), phosphorous acid (+3), hypodiphosphoric acid (+4) and phosphoric acid (+5).

Only a few examples will be mentioned from the large number of other flame-retardant compounds, in particular the inorganic or organic phosphates, phosphites, phosphonates, phosphate esters, red phosphorus and triphenylphosphine oxide.

Examples of phosphorus compounds of the phosphine class, which have the valence state −3, include aromatic phosphines, such as triphenylphosphine, tritolylphosphine, trinonylphosphine, trinaphthylphosphine and trisnonylphenylphosphine. Triphenyl-phosphine is particularly suitable.

Examples of phosphorus compounds of the diphosphine class, having the valence state −2, include tetraphenyldiphosphine and tetranaphthyldiphosphine. Tetranaphthyldiphosphine is particularly suitable.

Phosphorus compounds of the valence state −1 derive from phosphine oxide.

Phosphine oxides of the general formula I′ are suitable

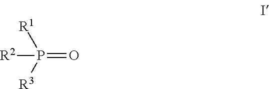

where R¹, R² and R³ in formula I′ are identical or different and are alkyl, aryl, alkylaryl or cycloalkyl groups having from 8 to 40 carbon atoms.

Examples of phosphine oxides are triphenylphosphine oxide, tritolylphosphine oxide, trisnonylphenylphosphine oxide, tricyclohexylphosphine oxide, tris(n-butyl)phosphine oxide, tris(n-hexyl)phosphine oxide, tris(n-octyl)phosphine oxide, tris(cyanoethyl)phosphine oxide, benzylbis(cyclohexyl)phosphine oxide, benzylbisphenylphosphine oxide and phenylbis(n-hexyl)phosphine oxide. Other preferred compounds are oxidized reaction products of phosphine with aldehydes, in particular of tert-butylphosphine with glyoxal. Particular preference is given to the use of triphenylphosphine oxide, tricyclohexylphosphine oxide, tris(n-octyl)phosphine oxide or tris(cyanoethyl)phosphine oxide, in particular triphenylphosphine oxide.

Other suitable compounds are triphenylphosphine sulfide and its derivatives as described above for phosphine oxides.

Phosphorus of the valence state +0 is elemental phosphorus. Red and black phosphorus are possible, and red phosphorus is preferred.

Examples of phosphorus compounds of the oxidation state +1 are hypophosphites of purely organic type, e.g. organic hypophosphites such as cellulose hypophosphite esters and esters of hypophosphorous acids with diols, e.g. that of 1,10-dodecanediol. It is also possible to use substituted phosphinic acids and anhydrides of these, e.g. diphenylphosphinic acid. Other possible compounds are diphenylphosphinic acid, di-p-tolylphosphinic acid and dicresylphosphinic anhydride. Compounds such as the bis(diphenylphosphinic) esters of hydroquinone, ethylene glycol and propylene glycol, inter alia, may also be used. Other suitable compounds are aryl(alkyl)phosphinamides, such as the dimethylamide of diphenylphosphinic acid, and sulfonamidoaryl(alkyl)phosphinic acid derivatives, such as p-tolylsulfonamidodiphenyl-phosphinic acid. Preference is given to use of the bis(diphenylphosphinic) ester of hydroquinone or of ethylene glycol, or the bis(diphenylphosphinate) of hydroquinone.

Phosphorus compounds of the oxidation state +3 derive from phosphorous acid. Suitable compounds are cyclic phosphonates which derive from pentaerythritol, neopentyl glycol or pyrocatechol, for example compounds of the formula II

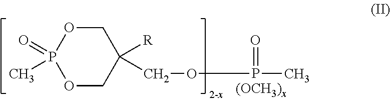

where R is a C₁-C₄-alkyl radical, preferably a methyl radical, x=0 or 1 (Amgard® P 45 from Albright & Wilson).

Phosphorus of the valence state +3 is also present in triaryl(alkyl) phosphites, such as triphenyl phosphite, tris(4-decylphenyl) phosphite, tris(2,4-di-tert-butylphenyl) phosphite and phenyl didecyl phosphite and so on. However, it is also possible to use diphosphites, such as propylene glycol 1,2-bis(diphosphite) or cyclic phosphites which derive from pentaerythritol, from neopentyl glycol or from pyrocatechol.

Particular preference is given to neopentyl glycol methylphosphonate and neopentyl glycol methyl phosphite, and also to pentaerythritol dimethyldiphosphonate and dimethyl pentaerythritol diphosphite.

Phosphorus compounds of oxidation state +4 which may be used are particularly hypodiphosphates, such as tetraphenyl hypodiphosphate and bisneopentyl hypodiphosphate.

Phosphorus compounds of oxidation state +5 which may be used are particularly alkyl- and aryl-substituted phosphates. Examples of these are phenyl bisdodecyl phosphate, phenyl ethyl hydrogenphosphate, phenyl bis(3,5,5-trimethylhexyl) phosphate, ethyl diphenyl phosphate, 2-ethylhexyl ditolyl phosphate, diphenyl hydrogenphosphate, bis(2-ethylhexyl) p-tolyl phosphate, tritolyl phosphate, bis(2-ethylhexyl) phenyl phosphate, di(nonyl) phenyl phosphate, phenyl methyl hydrogenphosphate, didodecyl p-tolyl phosphate, p-tolylbis(2,5,5-trimethylhexyl) phosphate and 2-ethylhexyl diphenyl phosphate. Particularly suitable phosphorus compounds are those in which each radical is aryloxy. Very particularly suitable compounds are triphenyl phosphate and resorcinol bis(diphenyl phosphate) and its ring-substituted derivatives of the general formula III (RDPs):

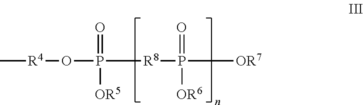

where:
R⁴-R⁷ are aromatic radicals having from 6 to 20 carbon atoms, preferably phenyl, which may have substitution by alkyl groups having from 1 to 4 carbon atoms, preferably methyl,
R⁸ is a bivalent phenol radical, preferably

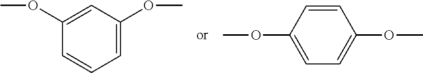

and n has an average value of from 0.1 to 100, preferably from 0.5 to 50, in particular from 0.8 to 10 and very particularly from 1 to 5.

Due to the process used for their manufacture, RDP products available commercially under the trade name Fyroflex® or Fyrol®-RDP (Akzo) and also CR 733-S (Daihachi) are mixtures of about 85% of RDP (n=1) with about 2.5% of triphenyl phosphate and also about 12.5% of oligomeric fractions in which the degree of oligomerization is mostly less than 10.

It is also possible to use cyclic phosphates. Of these, diphenyl pentaerythritol diphosphate and phenyl neopentyl phosphate are particularly suitable.

Besides the low-molecular-weight phosphorus compounds mentioned above, it is also possible to use oligomeric or polymeric phosphorus compounds.

Polymeric, halogen-free organic phosphorus compounds of this type with phosphorus in the polymer chain are produced, for example, in the preparation of pentacyclic unsaturated phosphine dihalides, as described, for example, in DE-A 20 36 173. The molecular weight of the polyphospholine oxides, measured by vapor pressure osmometry in dimethylformamide, should be in the range from 500 to 7000, preferably from 700 to 2000.

Phosphorus here has the oxidation state −1.

It is also possible to use inorganic coordination polymers of aryl(alkyl)phosphinic acids, such as poly-β-sodium(I) methylphenylphosphinate. Their preparation is given in DE-A 31 40 520. Phosphorus has the oxidation number −1.

Halogen-free polymeric phosphorus compounds of this type may also be produced by the reaction of a phosphonic acid chloride, such as phenyl-, methyl-, propyl-, styryl- or vinylphosphonyl dichloride, with dihydric phenols, such as hydroquinone, resorcinol, 2,3,5-trimethylhydroquinone, bisphenol A, or tetramethylbisphenol A.

Other flame-retardant compounds in the form of polymeric phosphorus compounds which may be present in the inventive molding compositions are prepared by reacting phosphorus oxytrichloride or phosphoric ester dichlorides with a mixture of mono-, di- or trihydric phenols and other compounds carrying hydroxy groups (cf. Houben-Weyl-Müller, Thieme-Verlag, Stuttgart, Germany, Organische Phosphorverbindungen Part II (1963)). It is also possible to produce polymeric phosphonates via transesterification reactions of phosphonic esters with dihydric phenols (cf. DE-A 29 25 208) or via reactions of phosphonic esters with diamines, or with diamides or hydrazides (cf. U.S. Pat. No. 4,403,075). The inorganic compound poly(ammonium phosphate) may also be used.

It is also possible to use oligomeric pentaerythritol phosphites, pentaerythritol phosphates and pentaerythritol phosphonates, in accordance with EP-B 8 486, for example Mobil Antiblaze® 19 (registered trade mark of Mobil Oil) (see formulae IV and V):

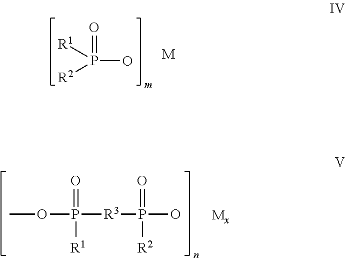

where the definitions of the substituents in the formulae IV and V are as follows:
R¹ and R² are hydrogen, C₁-C₆-alkyl, which optionally comprises a hydroxy group, preferably C₁-C₄-alkyl, linear or branched, e.g. methyl, ethyl, n-propyl, isopropyl, n-butyl, tert-butyl, n-pentyl; phenyl; where at least one radical R¹ or R² is preferably hydrogen and in particular R¹ and R² are hydrogen;
R³ is C₁-C₁₀-alkylene, linear or branched, e.g. methylene, ethylene, n-propylene, isopropylene, n-butylene, tert-butylene, n-pentylene, n-octylene, n-dodecylene;
   arylene, e.g. phenylene, naphthylene;
   alkylarylene, e.g. methylphenylene, ethylphenylene, tert-butylphenylene, methylnaphthylene, ethylnaphthylene, tert-butylnaphthylene;
   arylalkylene, e.g. phenylmethylene, phenylethylene, phenylpropylene, phenylbutylene;
M is an alkaline earth metal or alkali metal, Al, Zn, Fe, boron;
m is a whole number from 1 to 3;
n is a whole number of 1 and 3, and
x is 1 or 2.

Particular preference is given to compounds of the formula IV in which R¹ and R² are hydrogen, where M is preferably Ca, Zn or Al and very particular preference is given to calcium phosphinate.

Products of this type are commercially available, e.g. as calcium phosphinate.

Examples of suitable salts of the formula IV or V in which only one radical R¹ or R² is hydrogen are salts of phenylphosphinic acid, its Na and/or Ca salts being preferred.

Salts to which further preference is given have an alkyl radical R¹ and/or R² comprising hydroxy groups. These are obtained by way of example via hydroxymethylation. Preferred compounds are Ca, Zn and Al salts.

The average particle size D₅₀ (measured by the method described for component B2)) of these other flame-retardant compounds is preferably smaller than 10 μm, preferably smaller than 7 μm and in particular smaller than 5 μm.

The D₁₀ value is preferably smaller than 4 μm, in particular 3 μm and very particularly preferably smaller than 2 μm.

Preferred d₉₀ values are smaller than 40 μm and in particular smaller than 30 μm and very particularly preferably smaller than 20 μm.

Preference is further given to phosphorus compounds of the general formula VI:

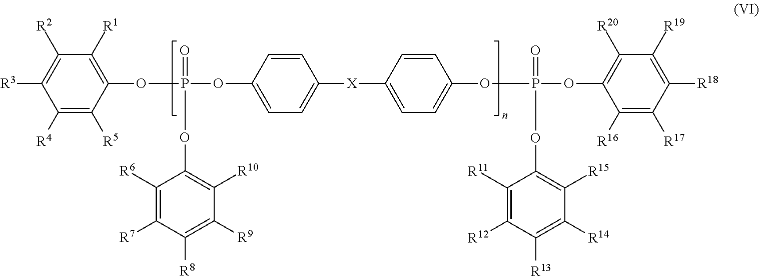

in which the definitions of the substituents in formula VI are as follows:
R¹-R²⁰, independently of one another, are hydrogen, or a linear or branched alkyl group having up to 6 carbon atoms
n has an average value of from 0.5 to 50, and
X is a single bond, C═O, S, SO₂, C(CH₃)₂.

Preferred other flame-retardant compounds are those of the formula VI in which R¹ to R²⁰, independently of one another, are hydrogen and/or a methyl radical. If R¹-R²⁰, independently of one another, are a methyl radical, preference is given to those compounds in which the radicals R¹, R⁵, R⁶, R¹⁰, R¹¹, R¹⁵, R¹⁶, R²⁰ in ortho-position with respect to the oxygen of the phosphate group are at least one methyl radical. Preference is also given to compounds B2) in which one methyl group is present per aromatic ring, preferably in ortho-position, and the other radicals are hydrogen.

Particularly preferred substituents are SO₂ and S, and C(CH₃)₂ is very particularly preferred for X in the above formula (VI).

The average value of n in the above formula (VI) is preferably from 0.5 to 5, in particular from 0.7 to 2, and in particular ≈1.

The statement of n as an average value is a consequence of the preparation process for the compounds listed above, the degree of oligomerization mostly being smaller than 10 and the content of triphenyl phosphate present being very small (mostly <5% by weight), there being a difference here from batch to batch. Compounds of this type are commercially available as CR-741 from Daihachi.

### Component C):

The thermoplastic molding compositions can comprise, as component C), one or more additives different from components A) and B). In principle, any of the additives conventionally used in plastics and known to the person skilled in the art and described in the literature are suitable. For the purposes of the present invention, examples of additives conventional in plastics are stabilizers and oxidation retardants, agents to counteract decomposition by heat and decomposition by ultraviolet light, lubricants and mold-release agents, dyes and pigments and plasticizers and also fibers, such as glass fibers or carbon fibers.

Examples of oxidation retardants and heat stabilizers that can be added to the thermoplastic molding composition of the invention are halides of metals of group I of the Periodic Table of the Elements, e.g. sodium halides, potassium halides and lithium halides. It is also possible to use zinc fluoride and zinc chloride. It is also possible to use sterically hindered phenols, hydroquinones, substituted representatives of this group, secondary aromatic amines, if appropriate in combination with phosphorus-containing acids, or salts of these compounds, or a mixture of these compounds, preferably in concentrations up to 1% by weight, based on the weight of the thermoplastic molding compositions.

Examples of UV stabilizers are various substituted resorcinols, salicylates, benzotriazols and benzophenones, the amounts of these generally used being up to 2% by weight, based on the weight of the thermoplastic molding compositions.

Lubricants and mold-release agents, the amounts of which that can be added being generally up to 1% by weight, based on the weight of the thermoplastic molding compositions, are stearic acid, stearyl alcohol, alkyl stearates and stearamides and also esters of pentaerythritol with long-chain fatty acids. It is also possible to use calcium stearates, zinc stearates or aluminum stearates or else dialkyl ketones, e.g. distearyl ketone. Zinc stearate, magnesium stearate and calcium stearate and also N,N′-ethylenebis(stearamide) are particularly suitable in the invention.

Glass fibers that can be used in the molding compositions of the invention are any of the glass fibers described in the literature and known to the person skilled in the art (see, for example, Milewski, J. V., Katz, H. S. “Handbook of Reinforcements for Plastics”, pages 233 ff., Van Nostrand Reinholt Company Inc, 1987).

### Preparation Process:

The thermoplastic molding compositions of the invention can be prepared by processes known per se, by using conventional apparatuses and conventional methods to mix the starting components. Examples of suitable mixing apparatuses are screw extruders, Brabender mixers or Banbury mixers. Mixing can, for example, be followed by extrusion. The extrudate can be cooled and comminuted. It is also possible to premix individual components and then to add the remainder of the starting materials individually and/or likewise in mixed form. The mixing temperatures are generally from 120 to 280° C.

The thermoplastic molding compositions of the invention have improved flame-retardant and/or mechanical properties when compared with molding compositions provided with known halogen-free or low-halogen-content flame-retardant combinations.

The molding compositions of the invention are suitable for the production of fibers, of foils, of moldings or of foams of any type. Fibers, foils, moldings, and foams comprising the molding compositions of the invention can be used, for example, as household items, electronic components, medical equipment, motor vehicle components or construction materials.

Examples are used below for further explanation of the invention.

### EXAMPLES

### Test Methods

Afterflame times t1 [s]:

In the fire test based on UL 94, vertical burning standard, afterflame time t1 was measured on specimens of thickness 1.6 mm after a first flame-application time of 10 seconds. The second afterflame time t2 was measured after a waiting time directly following extinguishment of the flames and after a second flame-application time of 10 seconds. The total of the afterflame times t1 and t2 gives the afterflame time t_{N}.

### Starting Materials

Components or examples with prefix “comp” are not inventive and serve for comparison.

### Thermoplastic Polymer (A):

Components A) used comprised:
a-I: a commercially available acrylonitrile-butadiene-styrene copolymer (ABS), Terluran® HI10 from BASF SE.
a-II: a styrene-acrylonitrile copolymer (SAN) comprising 34% by weight of acrylonitrile and 66% by weight of styrene with intrinsic viscosity 79 ml/g.

### Flame Retardant Component B):

Component B1) used comprised:
b1-I: Compound of the formula (I)

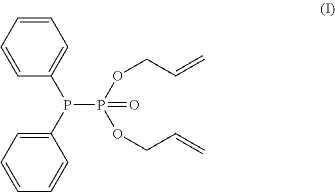

Component B2) used comprised:
b2-I: Nord-Min® 503 expandable graphite from Nordmann, Rassmann, GmbH.
Component B3) used comprised:
b3-I: TE-3893 Teflon® (polytetrafluoroethylene, PTFE) dispersion from C. H. Erbslöh.
Comparative component comp-B) used comprised:
comp-b-I: Disflammol® TP, a triphenyl phosphate from Lanxess Aktiengesellschaft.

### Production of Molding Compositions and Moldings and Testing of the Same:

To determine the fire properties mentioned in Table 1, components A) to B) (see Table 1 for respective parts by weight) were homogenized and extruded to give test specimens to UL 94, vertical burning standard, with thickness 1.6 mm.

TABLE 1
Constitution and properties of molding compositions
(prefix comp: for comparison)

| Example | comp-1 | comp-2 | comp-3 | 4 | 5 |
|---|---|---|---|---|---|
| Constitution [parts by wt.] | | | | | |
| a-I | 22.6 | 22.6 | 22.6 | 22.6 | 22.6 |
| a-II | 67 | 59 | 55 | 59 | 55 |
| b1-I | — | — | — | 8 | 12 |
| b2-I | 10 | 10 | 10 | 10 | 10 |
| b3-I* | 0.4 | 0.4 | 0.4 | 0.4 | 0.4 |
| V-b-I | — | 8 | 12 | — | — |
| Properties | | | | | |
| Afterflame time** t_{N} [s] | >50 | >50 | 26.1 | 12.3 | 3.1 |

*Calculated as solid
**Average value from 2 individual measurements

The examples confirm that the thermoplastic molding compositions of the invention have improved flame-retardant and/or mechanical properties when compared with molding compositions provided with known halogen-free or low-halogen-content flame retardant combinations.

1. A thermoplastic molding composition comprising
A) from 39 to 99% by weight of at least one thermoplastic polymer,
B) from 1 to 60% by weight of a flame-retardant component comprising
B1) a compound of the formula (I), 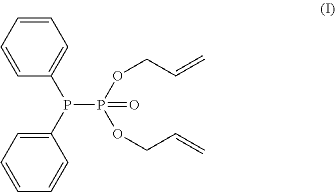
and
C) from 0 to 60% by weight of further additives,
where the percentages by weight are always based on the total weight of components A) to
C) and their total is 100% by weight.

2. The thermoplastic molding composition according to claim 1, comprising
from 50 to 95% by weight of component A),
from 5 to 40% by weight of component B) and
from 0 to 45% by weight of component C),
where the percentages by weight are always based on the total weight of components A) to C) and their total is 100% by weight.

3. The thermoplastic molding composition according to claim 1, wherein the flame-retardant component B) comprises
B1) a compound of the formula (I),
and in addition to this comprises either
B2) an expandable graphite, or
B3) a fluorine-containing polymer.

4. The thermoplastic molding composition according to claim 1,
wherein the flame-retardant component B) comprises
from 20 to 79.99% by weight of component B1),
from 20 to 79.99% by weight of component B2) and
from 0.01 to 4% by weight of component B3),
where the percentages by weight are always based on the total weight of components B1) to B3) and their total is 100% by weight.

5. The thermoplastic molding composition according to claim 1, comprising a fluorinated ethylene polymer as component B3).

6. The thermoplastic molding composition according to claim 1, comprising, as component A), polyethylene (PE), polypropylene (PP), polyvinyl chloride (PVC), polystyrene (PS), impact-modified polystyrene (HIPS), styrene-acrylonitrile copolymers (SAN), acrylonitrile-styrene-acrylate copolymers (ASA), acrylonitrile-butadiene-styrene copolymers (ABS), methacrylate-acrylonitrile-butadiene-styrene copolymers (MABS), styrene-butadiene block copolymers (SBC), polyamide (PA), polyethylene terephthalate (PET), polyethylene terephthalate glycol (PETG), polybutylene terephthalate (PBT), polyoxymethylene (POM), polycarbonate (PC), polymethyl methacrylate (PMMA), poly(ether)sulfones (PES), thermoplastically processable polyurethane (TPU), polyphenylene oxide (PPO), foamable and/or foamed polystyrene (EPS), foamable and/or foamed polypropylene or a mixture composed of two or more of these polymers.

7-27. (canceled)

28. A process for the preparation of the thermoplastic molding composition according to claim 1, which comprises mixing components A), B) and, optionally, C) with one another.

29. A molding comprising the compound of the formula (I) 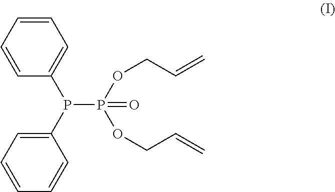
as flame retardant for thermoplastic polymers A).

30-49. (canceled)

50. The molding according to claim 29, where the thermoplastic polymer A) is foamable and/or foamed polypropylene.

51. (canceled)

52. A fiber, a foil, a molding, or a foam obtainable from the thermoplastic molding composition according to claim 1.
